(19) United States
(12) Patent Application Publication
(10) Pub. No.: US 2016/0027048 A1
(43) Pub. Date: Jan. 28, 2016

(54) AUDIENCE RECOMMENDATION

(71) Applicant: YAHOO! INC., Sunnyvale, CA (US)

(72) Inventors: Lin Ma, Sunnyvale, CA (US); Rohit Bhatia, Sunnyvale, CA (US); Xiao Han, Beijing (CN)

(73) Assignee: YAHOO! INC., Sunnyvale, CA (US)

(21) Appl. No.: 14/389,213

(22) PCT Filed: Jul. 25, 2014
(86) PCT No.: PCT/CN2014/083023

§ 371 Date: Sep. 29, 2014

(51) Int. Cl. G06Q 30/02

(52) U.S. Cl. CPC G06Q 30/0254

(57) ABSTRACT

Techniques are provided that include identifying and recommending one or more user segments as an audience for a particular campaign, such as an online advertising campaign, such as even if historical performance information for the particular campaign is limited or unavailable. Similar campaigns to the particular campaign may be identified. High-performing user segments for the similar campaigns may be identified. From these, one or more predicted best-performing user segments for the particular campaign may be identified and recommended as an audience for the particular campaign.

### BACKGROUND

In campaigns, such as online advertising campaigns, identifying a good or optimal audience, such as an audience of users, can significantly impact the campaign's success. Yet, many factors can, for example, make it difficult to do so, or to do so efficiently, optimally or quickly.

### SUMMARY

In some embodiments, techniques are provided that include identifying and recommending one or more user segments as an audience for a particular campaign, such as an online advertising campaign, such as even if historical performance or user information for the particular campaign is limited or unavailable. Similar campaigns to the particular campaign may be identified. High-performing user segments for the similar campaigns may be identified. From these, one or more predicted best-performing user segments for the particular campaign may be identified and recommended as an audience for the particular campaign.

In some embodiments, modeling of campaign information, including information about the particular campaign that may not include historical performance information, as well as information about other campaigns that includes historical performance information, is used in leveraging the information in determining a predicted high or best-performing user segment for the particular campaign.

In some embodiments, keyword-based information relating to campaigns, including the particular campaign and other campaigns, may be extracted or determined, and may be used in identifying similar campaigns. Performance of user segments within the similar campaigns may be leveraged in determining one or more high- or best-performing user segments for the particular campaign. Furthermore, in some embodiments, bias caused by non-audience-related factors may be identified and corrected for, such as to allow better or more accurate user segment performance assessment.

### BRIEF DESCRIPTION OF THE DRAWINGS

FIG. 1 illustrates a block diagram of a distributed computer system that can implement one or more aspects of an audience recommendation system or method according to one embodiment of the invention;

FIG. 2 illustrates a block diagram of an electronic device that can implement one or more aspects of an audience recommendation system or method according to one embodiment of the invention;

FIG. 3 illustrates a flow diagram of example operations of one or more aspects of an audience recommendation system or method according to one embodiment of the invention;

FIG. 4 illustrates a flow diagram of example operations of one or more aspects of an audience recommendation system or method according to one embodiment of the invention;

FIG. 5 illustrates a flow diagram of example operations of one or more aspects of an audience recommendation system or method according to one embodiment of the invention;

FIG. 6 illustrates a block diagram of one or more aspects of an audience recommendation system or method according to one embodiment of the invention;

FIG. 7 illustrates a block diagram of one or more aspects of an audience recommendation system or method according to one embodiment of the invention; and

FIG. 8 illustrates a block diagram of one or more aspects of an audience recommendation system or method according to one embodiment of the invention.

While the invention is described with reference to the above drawings, the drawings are intended to be illustrative, and the invention contemplates other embodiments within the spirit of the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.”

It is noted that description herein is not intended as an extensive overview, and as such, concepts may be simplified in the interests of clarity and brevity.

Herein, an advertiser can broadly include, for example, a proxy, representative, agent or associate of an advertiser, as well as managers, operators, etc., of advertising campaigns.

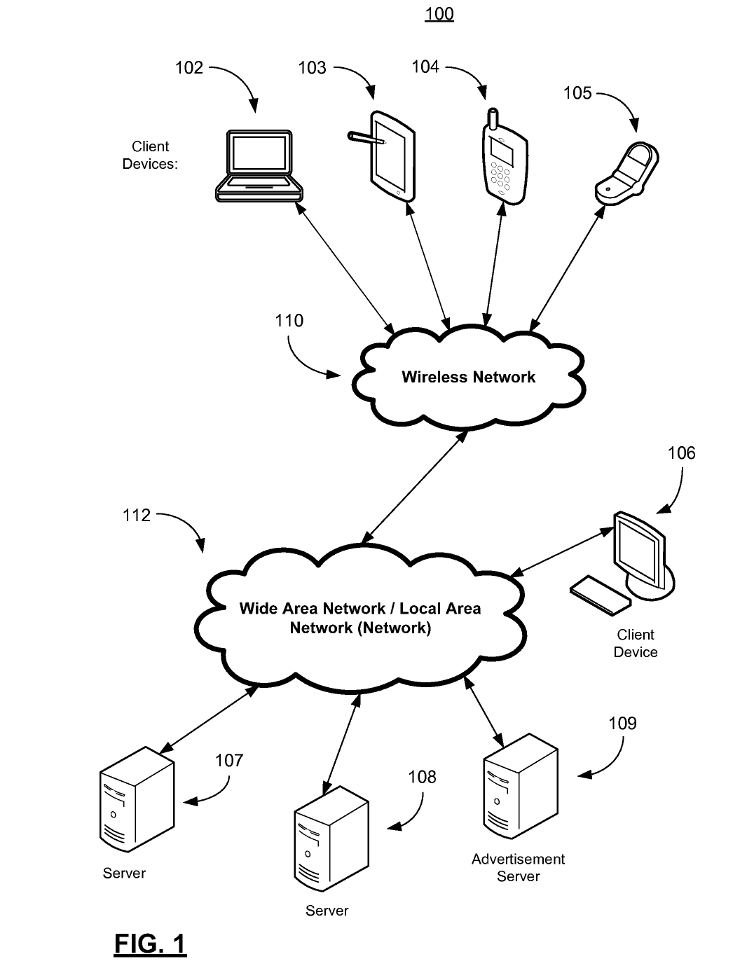

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more local area networks (“LANs”)/wide area networks (“WANs”) 112, one or more wireless networks 110, one or more wired or wireless client devices 106, mobile or other wireless client devices 102-106, servers 107-108 and one or more advertisement servers 109, and may include or communicate with one or more data stores or databases. Various of the client devices 102-106 may include, for example, desktop computers, laptop computers, set top boxes, tablets, cell phones, smart phones, etc. The servers 107-109 can include, for example, one or more application servers, content servers, search servers, etc.

An advertisement server can include, for example, a computer server that has a role in connection with online advertising, such as, for example, in obtaining, storing, determining, configuring, selecting, ranking, retrieving, targeting, matching, serving and presenting online advertisements to users, such as on websites, in applications, and other places where users will see them.

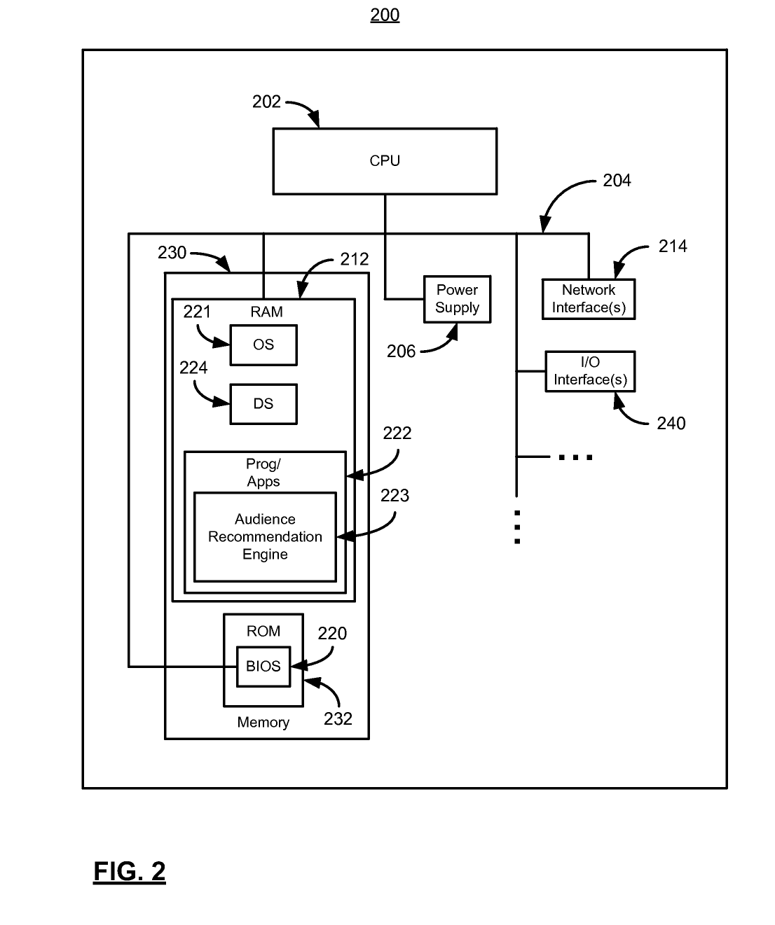

FIG. 2 illustrates a block diagram of an electronic device 200 that can implement one or more aspects of an audience recommendation system or method according to one embodiment of the invention. Instances of the electronic device 200 may include servers, e.g. servers 107-109, and client devices, e.g. client devices 102-106. In general, the electronic device 200 can include a processor 202, memory 230, a power supply 206, and input/output (I/O) components 240, e.g., microphones, speakers, displays, touchscreens, keyboards, keypads, GPS components, etc., which may be operable, for example, to provide graphical user interfaces. The electronic device 200 can also include a communications bus 204 that connects the aforementioned elements of the electronic device 200. Network interfaces 214 can include a receiver and a transmitter (or transceiver), and an antenna for wireless communications.

The processor 202 can include one or more of any type of processing device, e.g., a central processing unit (CPU). Also, for example, the processor can be central processing logic. Central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software controlled microprocessor, discrete logic, e.g., an application specific integrated circuit (ASIC), a programmable/programmed logic device, memory device containing instructions, etc., or combinatorial logic embodied in hardware. Furthermore, logic may also be fully embodied as software.

The memory 230, which can include RAM 212 and ROM 232, can be enabled by one or more of any type of memory device, e.g., a primary (directly accessible by the CPU) or secondary (indirectly accessible by the CPU) storage device (e.g., flash memory, magnetic disk, optical disk). The RAM can include an operating system 221, data storage 224, which may include one or more databases, and programs and/or applications 222, which can include, for example, software aspects of the audience recommendation program 223. The ROM 232 can also include BIOS 220 of the electronic device.

The audience recommendation program 223 is intended to broadly include or represent all programming, applications, algorithms, software and other tools necessary to implement or facilitate methods and systems according to embodiments of the invention. The elements of the audience recommendation program 223 may exist on a single server computer or be distributed among multiple computers or devices or entities, which can include advertisers, publishers, data providers, etc.

The power supply 206 contains one or more power components, and facilitates supply and management of power to the electronic device 200.

The input/output components, including I/O interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, and one or more input/output interfaces. A network care, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the audience recommendation program, via a network to another device. Also, an application server may, for example, host a Web site that can provide a user interface for administration of example aspects of the audience recommendation program.

Any computing device capable of sending, receiving, and processing data over a wired and/or a wireless network may act as a server, such as in facilitating aspects of implementations of the audience recommendation program. Thus, devices acting as a server may include devices such as dedicated rack-mounted servers, desktop computers, laptop computers, set top boxes, integrated devices combining one or more of the preceding devices, etc.

Servers may vary in widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, etc.

A server may include, for example, a device that is configured, or includes a configuration, to provide data or content via one or more networks to another device, such as in facilitating aspects of an example audience recommendation program. One or more servers may, for example, be used in hosting a Web site, such as the Yahoo! Web site. One or more servers may host a variety of sites, such as, for example, business sites, informational sites, social networking sites, educational sites, wikis, financial sites, government sites, personal sites, etc.

Servers may also, for example, provide a variety of services, such as Web services, third-party services, audio services, video services, email services, instant messaging (IM) services, SMS services, MMS services, FTP services, voice or IP (VOIP) services, calendaring services, phone services, advertising services etc., all of which may work in conjunction with example aspects of an example audience recommendation program. Content may include, for example, text, images, audio, video, advertisements, etc.

In example aspects of the audience recommendation program, client devices may include, for example, any computing device capable of sending and receiving data over a wired and/or a wireless network. Such client devices may include desktop computers as well as portable devices such as cellular telephones, smart phones, display pagers, radio frequency (RF) devices, infrared (IR) devices, Personal Digital Assistants (PDAs), handheld computers, GPS-enabled devices tablet computers, sensor-equipped devices, laptop computers, set top boxes, wearable computers, integrated devices combining one or more of the preceding devices, etc.

Client devices, as may be used in example audience recommendation programs, may range widely in terms of capabilities and features. For example, a cell phone, smart phone or tablet may have a numeric keypad and a few lines of monochrome LCD display on which only text may be displayed. In another example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 102-106, for example, as may be used in example audience recommendation program s, may run a variety of operating systems, including personal computer operating systems such as Windows, iOS or Linux, and mobile operating systems such as iOS, Android, and Windows Mobile, etc. Client devices may be used to run one or more applications that are configured to send or receive data from another computing device. Client applications may provide and receive textual content, multimedia information, etc. Client applications may perform actions such as browsing webpages, using a web search engine, sending and receiving messages via email, SMS, or MMS, playing games (such as fantasy sports leagues), receiving advertising, watching locally stored or streamed video, or participating in social networks.

In example aspects of the audience recommendation program, one or more networks, such as networks 110 or 112, for example, may couple servers and client devices with other computing devices, including through wireless network to client devices. A network may be enabled to employ any form of computer readable media for communicating information from one electronic device to another. A network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and a telephone link.

A wireless network, such as wireless network 110, as in an example audience recommendation program, may couple devices with a network. A wireless network may employ stand-alone ad-hoc networks, mesh networks, Wireless LAN (WLAN) networks, cellular networks, etc.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, etc. Access technologies such as 2G, 2.5G, 3G, 4G, and future access networks may enable wide area coverage for client devices, such as client devices with various degrees of mobility. For example, wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, etc. A wireless network may include virtually any wireless communication mechanism by which information may travel between client devices and another computing device, network, etc.

Internet Protocol may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), wide area networks (WANs), wireless networks, and long haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site

A “content delivery network” or “content distribution network” (CDN), as may be used in an example audience recommendation program, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf.

A peer-to-peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Some embodiments include direct or indirect use of social networks and social network information, such as in targeted advertising or advertisement selection. A “Social network” refers generally to a network of acquaintances, friends, family, colleagues, and/or coworkers, and potentially the subsequent connections within those networks. A social network, for example, may be utilized to find more relevant connections for a variety of activities, including, but not limited to, dating, job networking, receiving or providing service referrals, content sharing, creating new associations or maintaining existing associations with like-minded individuals, finding activity partners, performing or supporting commercial transactions, etc.

A social network may include individuals with similar experiences, opinions, education levels and/or backgrounds, or may be organized into subgroups according to user profile, where a member may belong to multiple subgroups. A user may have multiple “1:few” circles, such as their family, college classmates, or coworkers.

A person's online social network includes the person's set of direct relationships and/or indirect personal relationships. Direct personal relationships refers to relationships with people the user communicates with directly, which may include family members, friends, colleagues, coworkers, and the like. Indirect personal relationships refers to people with whom a person has not had some form of direct contact, such as a friend of a friend, or the like. Different privileges and permissions may be associated with those relationships. A social network may connect a person with other people or entities, such as companies, brands, or virtual persons. A person's connections on a social network may be represented visually by a “social graph” that represents each entity as a node and each relationship as an edge.

Users may interact with social networks through a variety of devices. Multi-modal communications technologies may enable consumers to engage in conversations across multiple devices and platforms, such as cell phones, smart phones, tablet computing devices, personal computers, televisions, SMS/MMS, email, instant messenger clients, forums, and social networking sites (such as Facebook, Twitter, and Google+), or others.

In some example audience recommendation programs, various monetization techniques or models may be used in connection with contextual or non-search related advertising, as well as in sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

The process of buying and selling online advertisements may include or require the involvement of a number of different entities, including advertisers, publishers, agencies, networks, and developers. To simplify this process, some companies provide mutual organization systems called “ad exchanges” that connect advertisers and publishers in a unified platform to facilitate the bidded buying and selling of online advertisement inventory from multiple ad networks. “Ad networks” refers to companies that aggregate ad space supply from publishers and provide en masse to advertisers.

For Web portals, such as Yahoo!, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

One approach to improving the effectiveness of presenting targeted advertisements to those users interested in receiving product information from various sellers is to employ demographic characteristics (i.e., age, income, sex, occupation, etc.) for predicting the behavior of groups of different users. Advertisements may be presented to each user in a targeted audience based upon predicted behaviors rather than in response to certain keyword search terms.

Another approach is profile-based ad targeting. In this approach, user profiles specific to each user are generated to model user behavior, for example, by tracking each user's path through a web site or network of sites, and then compiling a profile based on what pages and advertisements were delivered to the user. Using aggregated data, a correlation develops between users in a certain target audience and the products that those users purchase. The correlation then is used to target potential purchasers by targeting content or advertisements to the user at a later time.

During the presentation of advertisements, the presentation system may collect detailed information about the type of advertisements presented to the user. This information may be used for gathering analytic information on the advertising or potential advertising within the presentation. A broad range of analytic information may be gathered, including information specific to the advertising presentation system. Advertising analytics gathered may be transmitted to locations remote to the local advertising presentation system for storage or for further analysis. Where such advertising analytics transmittal is not immediately available, the gathered advertising analytics may be saved by the advertising presentation system until the transmittal of those advertising analytics becomes available.

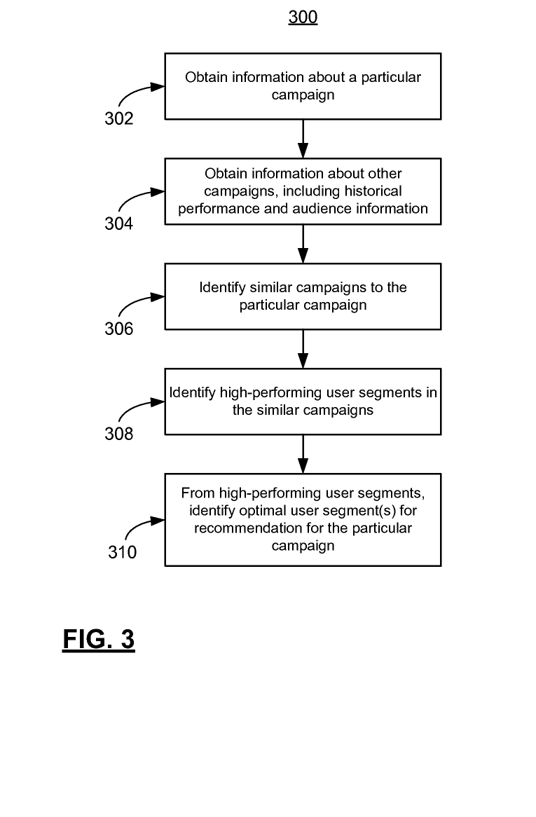

FIG. 3 illustrates a flow diagram 300 of example operations of one or more aspects of an audience recommendation system or method according to one embodiment of the invention. At step 302, information is obtained about a particular campaign.

At step 304, information is obtained about other campaigns, including historical performance and audience information.

At step 306, similar campaigns to the particular campaign are identified.

At step 308, high-performing user segments in the similar campaigns are identified. For example, in some embodiments, user segments may be ranked by campaign, and overall.

At step 310, from the high-performing user segments, one or more optimal user segments are identified for recommendation for the particular campaign.

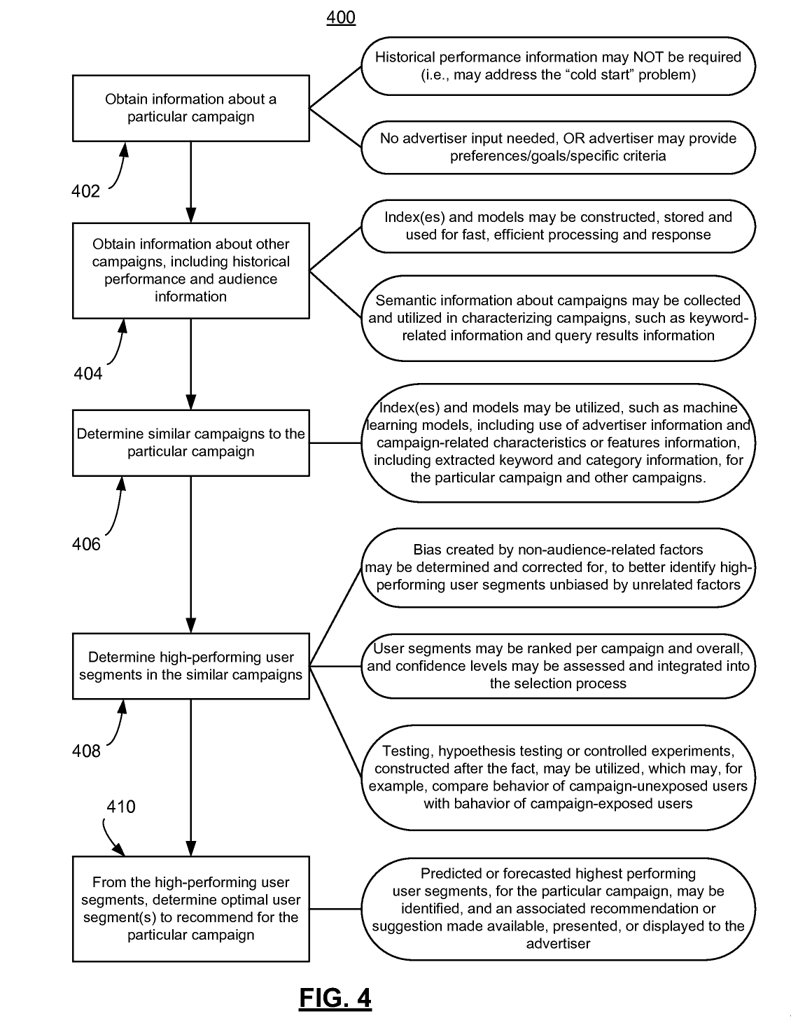

FIG. 4 illustrates a flow diagram 400 of example operations of one or more aspects of an audience recommendation system or method according to one embodiment of the invention. At step 402, information is obtained about a particular campaign. In some embodiments, historical performance information about the particular campaign may not be utilized or required (i.e., the “cold start” problem, which has been known to be difficult to solve). Furthermore, in some embodiments, no advertiser input, such as from an advertiser associated with the particular campaign, is needed or used. However, in some embodiments, advertiser input may be utilized or optionally provided and utilized, such as advertiser preference, goal, specific criteria, targeting criteria, other parameters, etc. If provided and utilized, the advertiser input may be used, for example, in influencing identification of similar campaigns or one or more user segments to recommend, or in one or more models that lead to or determine one or more user segments to recommend, or in other ways.

At step 404, information is obtained about other campaigns, including historical performance and audience information. In some embodiments, one or more indexes, models or graphs may be constructed and stored, and may be used, for example, to facilitate fast, efficient processing or response, and indexes, models or graphs may be used in various other steps as well. In some embodiments, indexes, models or graphs are constructed, trained or updated offline, to allow faster online computation or processing.

Furthermore, in some embodiments, semantic information about campaigns may be collected and utilized in characterizing campaigns, such as keyword-related information, and may include query results information that may be directly or indirectly related to a campaign or campaigns.

At step 406, similar campaigns to the particular campaign are determined or identified. In some embodiments, one or more indexes or models may be utilized, such as machine learning models, including use of advertiser information and campaign-related characteristics or features information, including extracted keyword and category information, for the particular campaign and other campaigns.

At step 408, high-performing user segments in the similar campaigns are determined or identified, such as using one or more models, indexes or graphs. In some embodiments, bias created by non-audience-related factors may be determined or identified and corrected for, such as to better identify high-performing user segments unbiased by unrelated factors. Furthermore, in some embodiments, user segments may be ranked per campaign and overall, and confidence levels may be assessed and integrated into the selection process. Still further, in some embodiments, testing, hypothesis testing, or constructed experiments from existing information, such as controlled experiments, may be utilized, such as in assessing performance levels associated with user segments. For example, this may include comparing behavior of campaign-unexposed users with behavior of campaign-exposed users.

At step 410, from high-performing user segments, optimal user segments are determined or identified to recommend for the particular campaign. In some embodiments, predicted or forecasted high-performing, highest-performing, or optimal user segments, relative to the particular campaign, may be determined or identified. In some embodiments, these may be made available, communicated, presented or displayed, such as to an advertiser associated with the particular campaign.

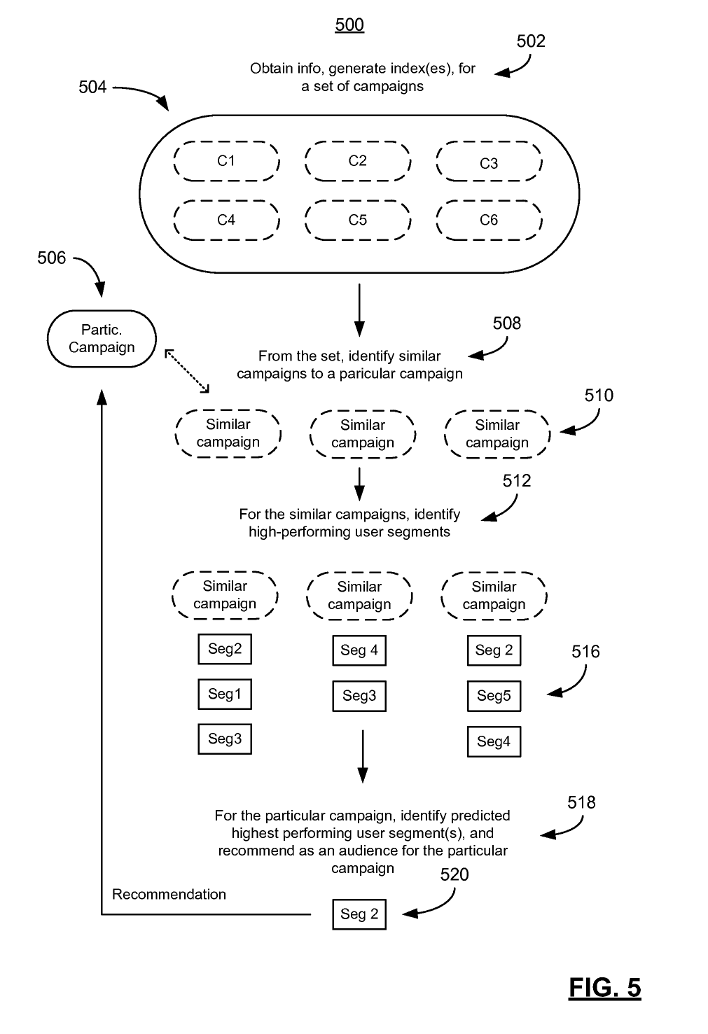

FIG. 5 illustrates a flow diagram 500 of example operations of one or more aspects of an audience recommendation system or method according to one embodiment of the invention. A step 502, information is obtained and one or more indexes are generated, for a set of campaigns. A representative set of such set of campaigns 504 is depicted.

At step 508, from the set, similar campaigns to a particular campaign 506 are identified. A representative set of such similar campaigns 510 is depicted.

At step 512, for the similar campaigns, high-performing user segments are identified. A representative set of such identified high-performing user segments 516 are depicted.

At step 518, for the particular campaign 506, predicted one or more highest-performing user segments are identified and recommended as an audience for the particular campaign 506. A representative such user segment, Seg 2 520, is depicted.

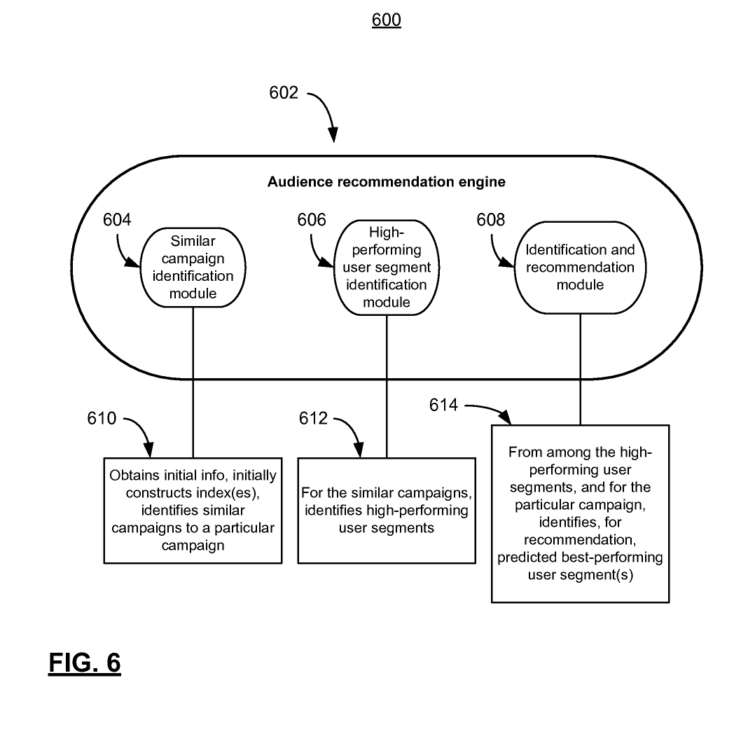

FIG. 6 illustrates a block diagram 600 of one or more aspects of an audience recommendation system or method according to one embodiment of the invention. An audience recommendation engine 602 is depicted. The engine 602 includes, potentially among other things and engines, a similar campaign identification module 604, a high-performing user segment identification module 606, and an identification and recommendation module 608.

As depicted at block 610, the similar campaign identification module 604 obtains initial information, at least initially constructs one or more indexes, and identifies similar campaigns to a particular campaign.

Furthermore, as depicted at block 612, the high-performing user segment identification module 606 identifies, for the similar campaigns, high-performing user segments.

Still further, as depicted at block 614, the identification and recommendation module 608 identifies for recommendation, from among the high-performing user segments, and for the particular campaign, one or more predicted best-performing user segments.

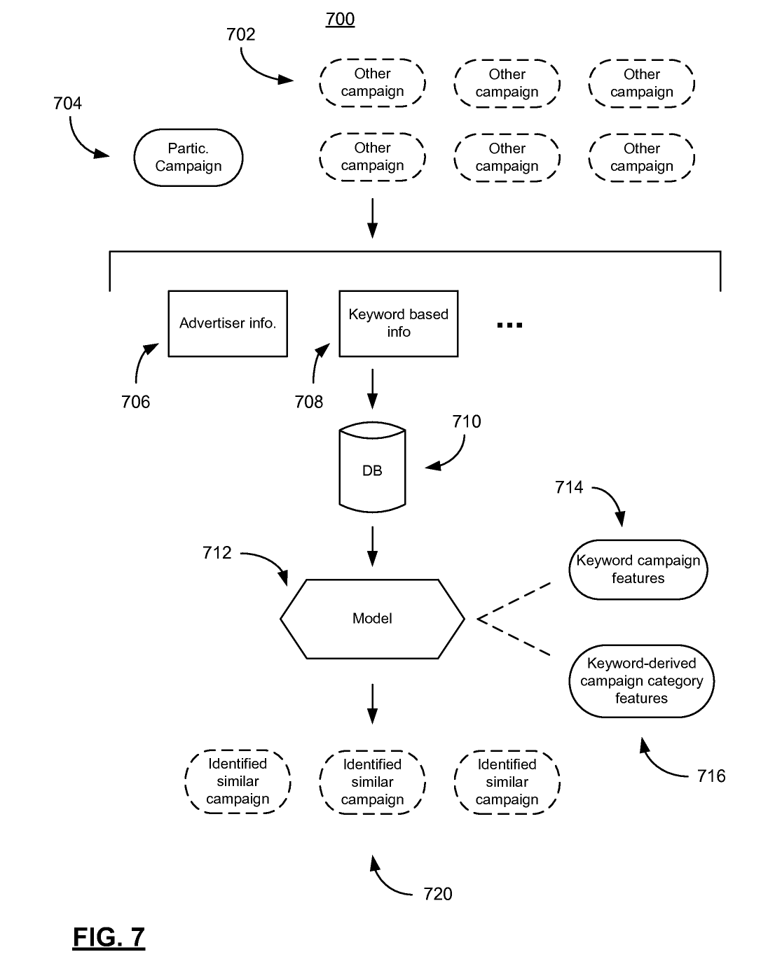

FIG. 7 illustrates a block diagram 700 of one or more aspects of an audience recommendation system or method according to one embodiment of the invention. A particular campaign 704, as well as other campaigns 702 are depicted.

Information relating to the campaigns, including advertiser information 706, keyword-based information 708, and potentially other information is collected and stored in a database 710, and used as input to one or more models 712, such as one or more stochastic, matrix-based or machine learning models.

In some embodiments, as depicted, the one or more models may use keyword campaign features 714 and keyword-derived campaign category features 716. For example, in some embodiments, a two dimensional feature space may be utilized, and vectors may be constructed and compared for similarity. The one or more models, as well as potentially other things, such as one or more indexes, may be utilized in identifying similar campaigns 720 to the particular campaign 704.

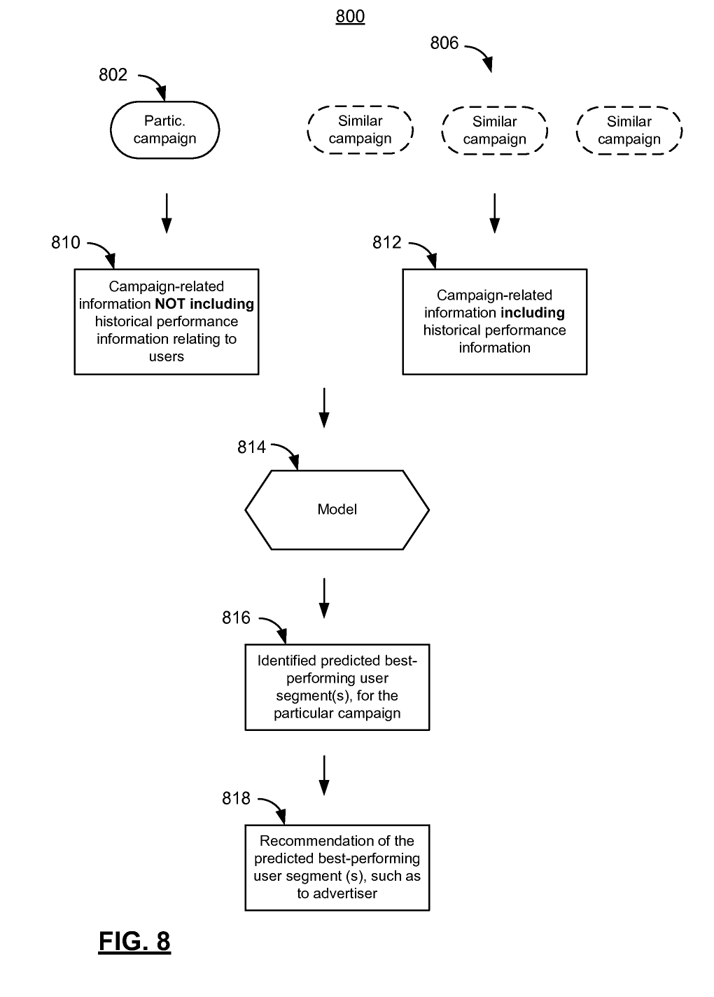

FIG. 8 illustrates a block diagram 800 of one or more aspects of an audience recommendation system or method according to one embodiment of the invention. A particular campaign 802 and identified similar campaigns 806 are depicted.

Block 810 represents obtained information relating to the particular campaign 802, which does not include historical performance information. However, block 812 represents obtained information relating to the similar campaigns, which does include historical performance information.

The information represented by blocks 810 and 812, as well as potentially other information and constructs, such as one or more indexes, graphs or derived information, is used by the model 814. Using the model, one or more predicted best-performing user segments are identified, for the particular campaign 816.

As represented by block 818, a recommendation is provided of the predicted best-performing user segment(s), such as to an advertiser associated with the particular campaign 802.

Some embodiments of the invention provide a recommendation of one or more user segments for use as an audience in a campaign, such as an online advertising campaign or other user-directed campaign, such an electronic or online campaign or content serving-based campaign. In various embodiments, a campaign can be planned or can already have been initiated. In some various embodiments, a recommendation can broadly cover items such as suggestions, implicit recommendations, etc. For example, in some embodiments, a user segment may be explicitly recommended, but in other embodiments, a recommendation may take the form of a suggestion, question, or invitation, such as, for example, a suggestion that an advertiser may wish to consider utilizing a specified user segment as an audience in an advertising campaign. In some embodiments, the advertiser may utilize users in the user segment to serve, or target and serve, ads to, for example.

In various embodiments, a user segment may be defined in different ways. In some embodiments, a user segment may be defined as a specific group of individual users. In other embodiments, a user segment may be defined based on targeting, profiling or other criteria, such that the individual users that make up the user segment may not be set, but may change, for example, over time.

In some embodiments, an audience includes users that are targeted to participate, or actually participate, in some way, in a campaign. For example, an advertising campaign audience may include users that are targeted or served ads or impressions, some of which users may click through, convert, etc.

In some embodiments, various information is obtained about campaigns. For example, in some embodiments, advertiser, audience and historical campaign performance information may be obtained directly or indirectly from an online advertising exchange or parties associated with it, such as advertisers, publishers, users or data providers. Information may also be obtained directly or indirectly from, for example, a content distribution or advertising marketplace or exchange, or one or more operators, managers, or partners thereof. Historical performance information, for an advertising campaign, may include targeted or served impressions or ads, users and user segments targeted or served ads and their behavior, click throughs, conversions, etc., as well as ads themselves, types of ads, creative, content and brands or subjects associated with ads, publishers and sites where ads are served etc. Other obtained information may include information about advertisers associated with campaigns.

In some embodiments, campaign information (including campaign-associated information, such as advertiser information, etc.) is stored in one or more databases and used in constructing one or more indexes or graphs, such as user graphs or user group graphs. For example, the indexes may include efficiently stored and organized information, such as may allow for fast and efficient querying, searching, analyzing and obtaining results relating to the stored information. Furthermore, in some embodiments, models may be utilized that allow for information-related analysis and determinations. Models may, for example, including machine learning models and matrix-related models.

Some embodiments do not require or do not utilize historical performance information relating to the particular campaign, which may in some embodiments include not requiring or utilizing audience or targeted audience information. For example, such information may be difficult to obtain, may involve advertiser, user or other entity privacy issues, or partner issues, may require actions or authorizations from an advertiser associated with the particular campaign, etc. However, in some embodiments, historical performance information, which may include audience and user information, or limited such information, is utilized, such as by being incorporated or represented in one or more indexes or models.

In some embodiments, indexes, models or graphs may be constructed, maintained, updated, trained, etc., in whole or in part offline, such as through Web crawling, spidering, etc. In some embodiments, a query may be made to obtain one or more user segments for recommendation as an audience for a particular campaign. For example, the query may be made online or in real time, and results may be obtained very quickly or in real time or substantially in real time, such as in less than a minute, seconds, or a fraction of a second, which may include utilizing one or more offline-constructed or updated indexes, models or graphs. In some ways, aspects of this may be analogous to online search engines using pre-constructed indexes to facilitate rapid or real-time determination or search results.

In some embodiments, queries may be run without human input, such as based on a program for running queries, determining recommended user segments for particular campaigns, and making available or displaying the recommendations, such as to advertisers associated with the particular campaigns. In some embodiments, queries may be partly or wholly human submitted, for example, by an entity or party wishing to obtain a recommendation to provide to, for example, an advertiser. In other embodiments, advertisers themselves can run queries to determine recommendations, or explore various hypotheticals, user segments, campaign or audience modifications, etc.

Furthermore, in some embodiments, one more tools, such as GUI-based or online tools, may be made available, such as to advertisers. In some embodiments, for example, using such a tool, an advertiser may be able to request and obtain recommendations, or different recommendations based on different input advertiser priorities or parameters, etc. Still further, in some embodiments, information and results may be provided, to advertisers, or others, beyond recommended user segments. For example, in some embodiments, advertisers or other parties may use such a tool to explore similar campaigns, effects of different audiences, effects of different campaign parameters, etc., such as on performance or specified performance aspects.

In some embodiments, scores, such as numerical scores, may be utilized in models or algorithms, such as may be related to strength or confidence of associations or similarity, such as similarity of campaigns to a particular campaign, scores relating to a performance level of a user segment, etc. In some embodiments, information, including information about the advertiser, as well as information about the particular campaign that may not include historical performance information, is used in characterizing and analyzing the particular campaign. This can be considered a form of “cold start” problem. Similar types of information may be utilized with regard to other campaigns, but also historical performance information, which may include performance in connection with audience, user, and user segment information, which user segment information may be explicit or implicit, derived or gatherable, such as from audience and performance information.

In some embodiments, keyword-related information, or semantics or semantic information, is obtained regarding campaigns, such as the particular campaign and other campaigns. For example, in some embodiments, such information may include keywords that are extracted, such as by being found and obtained, relating to such campaigns, directly or indirectly. For example, obtained keywords may include keywords associated with the advertiser, area of the advertiser, brand, products or services associated with the advertiser, etc. Obtained keywords may also include keywords associated directly with the campaign, such as keywords associated with the campaign itself, campaign brands, products, services, targets, types thereof, etc. Furthermore, obtained keywords associated with campaigns can include keywords obtained from advertisements and creatives associated with the campaign. Still further, obtained keywords can include other keywords, such as keywords that may be less directly associated or may be derived, or more indirectly or actively derived.

In some embodiments, obtained keywords may include keywords obtained from, for example, landing pages, or Web sites and linked pages, associated with content or advertisements. Still further, in some embodiments, active steps may be taken, or rapidly or instantly taken, to obtain keywords. In some embodiments, searches, such as keyword searches, may be run, such as keyword searches on an online search engine or Web site. Keywords may then be obtained from results from the search results, or keywords associated with results. For example, a keyword search may be run relating to a campaign, such as a brand associated with the campaign, or description of the campaign, or other parameter. The results of the search may be analyzed to extract keywords, such as keywords associated with hits or individual results within the search results, including titles, creatives, and links that may be associated with such hits. Furthermore, individual hits may be actively examined, directly, indirectly or actively, such as by obtaining keywords from landing pages or web sites associated with clicking on the hits, or links or other pages associated with such landing pages, etc.

In some embodiments, techniques such as described in the foregoing may be used to improve, enhance or supplement information to characterize campaigns, such as the particular campaign. In some embodiments, even if historical performance information associated with the particular campaign is not used, information characterizing the particular campaign can be obtained, such as from obtained keywords. This, in turn, in combination with information about other campaigns, can be effectively used in finding similar campaigns to the particular campaign, and eventually in identifying one or user segments to recommend in connection with the particular campaign, such as may include the use of indexes, models, graphs, algorithms, etc.

While, in some embodiments, no input or activity is required in connection with the particular campaign, such as any input from an advertiser associated therewith, in other embodiments, input, which may for example, be optional at the option of an advertiser, may be provided and used. For example, in some embodiments, an advertiser associated with a particular campaign may provide hints, parameters, targeting criteria, preferences, etc., that may be used or factored into identification of a user segment to recommend. For example, an advertiser may express positive or negative preference in the form of audience targeting criteria, profile parameters, etc., which can include, among other things, parameters based on audience demographics (i.e., age or location restrictions, or criteria), performance priorities (i.e., conversions more important than clicks, and to what degree), or many others.

In some embodiments, other campaigns for which information is utilized can include various types of advertising campaigns, such as, for example, guaranteed delivery, non-guaranteed delivery, native advertising, display advertising, search or sponsored search advertising, social network-related advertising, etc. For example, information from such various campaigns can be used to enrich and enhance indexes, graphs and models, whether or not all such campaigns are included among campaigns assessed to identify similar campaigns, etc.

In some embodiments, obtained campaign-associated semantic or keyword information, and information derived therefrom, can be organized into several types of features, such as a keyword feature and a category feature. In some embodiments, groups of keywords associated with advertisers or campaigns can be analyzed and used to determine categories of advertisers and campaigns, which can then be used as the category feature, and used in identification of similar campaigns. In some embodiments, advertiser similarity, or other similarities, can be used or factored into finding similar campaigns. For example, in some embodiments, a vertical, such as a brand, product or service, or type of brand, product or service, associated with a campaign, or keywords associated therewith, may be used in characterizing a campaign or in feature determination, and may be factored into determining similarity between campaigns.

For example, using keyword features and categories, in some embodiments, obtained keywords may be used to define a two-dimensional feature space, which may be used in one or more models. For example, in some embodiments, individual campaigns may be represented as vectors in the feature space, and similarly between such campaigns and the particular campaign may be measured in whole or in part based on this, which may include strength-related scoring, etc.

In some embodiments, in assessing or identifying similar campaigns, identifying high-performing user segments, or identifying a predicted best-performing user segment to recommend for a particular campaign, techniques may be employed to correct for bias that may enter into the analyses and computations. For example, in some embodiments, algorithmic or computational techniques are employed to identify, measure, and correct for or remove identified bias with respect to assessing user segments. For example, in some embodiments, non-audience-related bias may affect such assessment, such as by affecting campaign performance, such as the quality of an advertising campaign affecting performance, which may skew computation or assessment of a user segment. As such, in some embodiments, such bias is identified and computationally factored out, so as to lead to more pure and accurate user segment characterization, and lead to better identification of the high-performing user segments, and the predicted best-performing user segment, for example. Bias can be caused by many factors, such as, for example, time-related factors, such as time of day, daily, weekly, monthly or seasonal factors, price-related factors, creative-related factors, brand-related factors, campaign quality-related factors, advertiser-related factors, location-related factors, etc.

In some embodiments, testing or hypothesis testing may be used in assessing user segments, such as in assessing performance effects of users and user segments. For example, in some embodiments, performance (such click through rates, conversions, actions, etc.) for campaign-unexposed users may be compared, contrasted or measured against performance for campaign-exposed users. This, in turn, may allow better determination of the effect of campaign factors on performance, which may facilitate determining bias in user segment assessment, determining similar campaigns, etc. For example, in some embodiments, using obtained historical performance information, after-the-fact controlled experiments can in effect be run and the results utilized in such determinations and identifications, including by being represented or factored into scores, models, graphs, indexes, etc. Furthermore, in some embodiments, for example, confidence levels associated with determinations relating to campaigns or user segments may be measured and factored into other determinations and identifications that may make use of the measures associated with the confidence levels.

For example, in some embodiments, confidence levels may be determined that are based on a statistical evaluation of whether sufficient statistical confidence has been determined to reach a high enough level such that a judgment or assessment may be made that a given user segment performs better than an average user segment, for a given campaign. This can include taking into account such factors as segment qualification, as a high-performing user segment, based on performance (such as click or conversion statistics) and the relationship to determined performance statistics associated with non-high-performing user segment, for example. In some embodiments, if a user segment is determined to qualify as a high-performing segment, an assessment, estimation or determination is made as to how much of a lift in performance is provided by the high-performing user segment, such as compared to the average, what level of confidence is available regarding this lift. Furthermore, in some embodiments, a stability level associated with the high-performing user segment is determined and factored into assessment of the user segment.

In some embodiments, semantic match techniques are used in determining similar campaigns to a particular campaign, as well as hypothesis testing to determine sufficient confidence, for example, to qualify a user segment as a determined high-performing user segment. Bias determination and correction, and calculation of stability of the segment, such as using chi-square testing, and modeling, may also be factored into the determination of whether a user segment is high-performing, and to what degree.

In some embodiments, user qualified user segments, including those not previously booked by an advertiser are utilized, rather than user segments actually booked or purchased with respect to advertisement serving by an advertiser. Reasons for this include that advertiser bookings may incorporate bias toward such user segments, which in turn means that certain potentially high-performing user segments may be overlooked if advertiser-booked user segments only are considered. Furthermore, looking beyond advertiser-booked user segments allows an opportunity to recommend, use, and evaluate the performance and value of new user segments, which could include using user qualification estimation information in user profiling, for example. Still further, looking beyond just advertiser-booked user segments allows a relatively broad, more objective and comprehensive cross-section and selection of user segments.

In some embodiments, hypothesis testing may be utilized in determining whether a user segment is high-performing. For example, supposing that CVRs represents the conversion rate of an impression from a specific user segment in a campaign to be assessed, and CVR_{AOS} represents average conversion rate of an impression from all other segments in the same campaign. Utilized samples may include exposed user impressions in a specific user segment in a specific campaign, which may be represented as a Bernoulli distribution based on conversion rates, where standard error may expressed as:

S=√[(1/n−1)(Σxᵢ−x_{avg})²] (Eq. 1)

Supposing that xᵢ=1 for a convertor event, xᵢ=o otherwise,

√{[1/(#imp−1)](1−CVR_{AOS})²(#conv)+[1/(#imp−1)](CVR_{AOS})²(#impr−#conv)} (Eq. 2)

### Test Statistics:

t=(CVR_{S}−CVR_{AOS})/[S/(√#imp)] (Eq. 3)

In some embodiments, when estimating the CVR of an impression from the whole segment, a low margin of error is used to give a conservative estimation. In some embodiments, when N is large, in implementation, normal distribution is used to approximate t distribution, such as to avoid degree of freedom table look-ups, for example.

CVR_{S}adjusted=CVR_{S}−qnorm(0.95)*s/sqrt(n) (Eq. 4)

Lift by the segment may be measured by:

CVR_{S}adjusted/CVR_{AOS} (Eq. 5)

In some embodiments, calculated performance may be judged including incorporation of effects from multiple factors, such as recently (i.e., based on when the user qualified for inclusion in the segment), frequency cap, day parting, etc. In some embodiments, these may be combined to give a multivariable estimation.

In some embodiments, Pearson's chi-square test method is utilized, since it is a general method that does not assume any segment population distribution.

In some embodiments, population distribution may be binned into two dimensions, recentness and frequency, which may, for example, lead to a table such as the following, which may represent population distribution of an SRT segment in a recent period (e.g., 30 days):

TABLE 1

| SRT segment 123 | Frequency = 1 | Frequency = 2 | Frequency > 2 |
|---|---|---|---|
| Recentness <= 7 days | X1 | X2 | X3 |
| Recentness = 8-14 | X4 | X5 | X6 |
| days | | | |
| Recentness > 14 days | X7 | X8 | X9 |

The following may represent population distribution of an SRT segment in a longer period (e.g., 2 quarter):

TABLE 2

| SRT segment 123 | Frequency = 1 | Frequency = 2 | Frequency > 2 |
|---|---|---|---|
| Recentness <= 7 days | Y1 | Y2 | Y3 |
| Recentness = 8-14 | Y4 | Y5 | Y6 |
| days | | | |
| Recentness > 14 days | Y7 | Y8 | Y9 |

Degree of freedom may be # of recentness bins*(# of frequency bins−1).

Statistic may be given as:

χ²=Σ[(xi−yi)²/yᵢ] (Eq 6)

In some embodiments, chi-square testing may be used to determine if short term population distributions in bins fit long term population distributions in the same bins.

In some embodiments, similar techniques may be used in binning users into different score ranges, such as may be calculated by models, for example.

In some embodiments, techniques are utilized to rank user segments according to performance level. For example, in some embodiments, hypothesis testing or bias correction may be utilized in such ranking, for example, to normalize, such as by ranking according to identical campaign conditions, other than user-related factors. Furthermore, in some embodiments, functions may be utilized, of selected parameters, in this regard. For example, click through rate (CTR) or another performance parameter may be assessed as a function of one or more particular, controllable or selected parameters, such as audience, publisher, advertiser, price, seasonality, etc. Hypothesis testing or bias correction, or both, can be utilized in determining CTR as a function of more limited variables.

Overall, some embodiments provide solutions, such as to automatically or partially automatically recommend an audience to an advertiser, such as in whole or in part to help an advertiser achieve high performance, objectives, or specific performance objectives, such as in advertising various marketplaces, which can include display, search advertising, native advertising, guaranteed delivery, non-guaranteed delivery, etc. In some embodiments, in some ways analogously to a Web search engine returning relevant results based on a keyword search, some embodiments provide tools that provide good user segment match results for a new campaign search query. Some embodiments, for example, can recommend user segments with otherwise limited or no use marketplace use, and can increase advertiser and campaign reach and marketplace efficiency. Furthermore, some embodiments provide recommendations to bidders in auction-based advertising marketplaces, such as to inform or recommend user segments to bid on, or how much to bid, as well as to allow bidders to explore user segments and other parameters affecting potential bidding, such as in a multi-armed bandit-related manner, or otherwise.

In some embodiments, recommendations are automatically provided to advertisers, which can increase efficiency, campaign performance and reach. Recommendations and automatic recommendations can also simplify and enhance workflow, such as between parties involved, and can reduce the need to prepare and share data, such as by an exchange or marketplace provider, operator or manager.

Some embodiment provide reliable and accurate recommendations for the use of advertisers. Furthermore, some embodiments include use of algorithms to distinguish the contribution to campaign performance by an audience, as opposed to other factors, such as by identifying, measuring, and correcting for bias, such as in computational models. This can help ensure that recommendations are truly and accurately for high-performing user segments, as opposed to just user segments associated with historically high-performing campaigns, for instance.

Some embodiments can benefit and be used in or with various types of advertising marketplaces, including display, search, native, guaranteed delivery, non-guaranteed delivery, etc. Furthermore, data collected from many different campaigns can be collected, integrated and used, such as in indexes and models. For example, if a new campaign to be booked in native advertising, the advertiser can be provided with a recommended user segment, which recommendation determination benefits from data collected not just from the native advertising marketplace, but other marketplaces as well. This, in turn, for example, can contribute to building a unified, integrated marketplace and data mart, helping to optimize various or all types of advertising campaigns.

Some embodiments avoid the need for advertisers to rely on personal knowledge to input such parameters as similar or look-alike campaigns, or knowledge about user segments or audiences that they have used in the past, which can block or prevent them from exploring and using a new user segment or audience that they lack prior experience about. Some embodiments further avoid the need for advertisers to provide historically high-performing user segment information and then allow a computerized system to make adjustments or selections accordingly. Advertisers often lack sufficient knowledge or time to provide such input, or adequate such input, or their input is too limited, narrow, or just sub-optimal. In some embodiments, user segments are identified and recommended with no need for input from the advertiser, such an input on similar campaigns or desired or high-performing user segments or audiences. Some embodiments provide a reliable, cross-campaign audience reference, tool, or way to automatically provide recommended audiences for campaigns.

Some embodiments use indexing and indexes in various aspects or steps. In some embodiments, for example, campaigns in various marketplaces, such as, for example, display, search, native, guaranteed, non-guaranteed, etc., are indexed, such as by keyword features and category features, which indexing and indexes are used in finding similar campaigns. Furthermore, in some embodiments, high-performing audiences and audience characteristics and parameters are indexed in campaigns. Some embodiments provide solutions using what might be considered in some ways more objective criteria, as may be provided by the indexes, as opposed to what might be considered in some ways more subjective criteria, as may be provided by advertiser input, thereby increasing efficiency, ease of use, and quality of results. Furthermore, some embodiments provide solutions to rank, for example, in order of performance level, high-performing user segments in similar campaigns, as well as predicted highest-performing user segments for a particular campaign.

As described above, some embodiments use vectors in features spaces. For example, some embodiments use vectors related to keywords and weights associated with strength of the association with the keyword, to represent entire campaigns or aspects thereof. In some embodiments, a vector associated with a campaign can be determined based on two vector components, including a keyword feature vector component and a category feature vector component. Vectors can be determined based on or derived from keywords or groups of keywords obtained in the ways described previously, for example, along with incorporating any input from the advertiser, such as any advertiser priorities, parameters, etc. In some embodiments, vectors can be determined for each of a number of campaigns, as well as the particular campaign, and can be compared to determine similar or most similar campaigns to the particular campaign, where similar vectors may indicated similar campaigns, and strength of similarity may correlate with strength of similarity of campaigns. Vectors and vector comparisons can also be utilized in connection with identifying one or more predicted best-performing user segments to recommend, in comparing user segments, and in other ways.

In some embodiments, as described above, bias relating to assessment of user segments may be identified, measured and corrected for or removed, such as in computational models.

While the invention is described with reference to the above drawings, the drawings are intended to be illustrative, and the invention contemplates other embodiments within the spirit of the invention.

1. A system comprising one or more processors and a non-transitory storage medium comprising program logic for execution by the one or more processors, the program logic comprising:
an audience recommendation engine, comprising:
a similar campaign identification module that obtains, stores and constructs one or more indexes using, information about each of a set of campaigns, including historical performance information and audience information, and identifies, from the set of campaigns, utilizing the one or more indexes and information about a particular campaign, a set of similar campaigns to the particular campaign;
a high-performing user segment identification module that identifies, utilizing the one or more indexes, a set of high-performing user segments relating to the similar campaigns; and
an identification and recommendation module that identifies, utilizing the one or more indexes, from the high-performing user segments, one or more user segments for recommendation as an audience for the particular campaign, wherein the one or more user segments are forecasted to be best-performing of the high-performing user segments, for the particular campaign.

2. The system of claim 1, wherein the audience determination engine does not require historical performance information about the particular campaign.

3. The system of claim 1, comprising the identification and recommendation module generating, and displaying to an advertiser, a recommendation of the one or more user segments as an audience for the particular campaign.

4. The system of claim 1, wherein the campaign is an online advertising campaign.

5. The system of claim 1, wherein use of offline indexing allows faster determination of the recommendation than without the use of offline indexing.

6. The system of claim 1, wherein identifying high-performing user segments comprises correcting for bias caused by non-audience-related campaign factors affecting campaign performance.

7. The system of claim 1, wherein identifying high-performing user segments comprises correcting for bias caused by non-audience-related campaign factors affecting campaign performance, including testing that compares performance in campaign-unexposed users to performance in campaign-exposed users.

8. The system of claim 1, wherein identifying high-performing user segments comprises correcting for bias caused by non-audience-related campaign factors affecting campaign performance, and wherein the factors include at least one brand-related factor, at least one time-related factor, a least one price-related factor and at least one creative-related factor.

9. The system of claim 1, wherein the one or more indexes include use of information from advertising campaigns including guaranteed delivery advertising campaigns, non-guaranteed delivery advertising campaigns, native advertising campaigns, and display advertising campaigns.

10. The system of claim 1, wherein no input is required from an advertiser associated with the particular campaign, in order to determine the recommendation.

11. The system of claim 1, wherein an advertiser associated with the particular campaign can provide preference, goal or priority information which information is used in affecting and determining the recommendation.

12. The system of claim 1, wherein the one or more indexes utilize semantic information obtained about advertising campaigns, including keywords obtained from campaigns, elements of campaigns, and search results directly or indirectly associated with campaigns.

13. The system of claim 1, wherein the one or more indexes utilize semantic information obtained about advertising campaigns, including determined categories associated with campaigns.

14. A method comprising:
obtaining, storing and constructing one or more indexes using, information about each of a set of campaigns, including historical performance information and audience information;
identifying, from the set of campaigns, utilizing the one or more indexes and information about a particular campaign not including historical performance information relating to the particular campaign, a set of similar campaigns to the particular campaign;
identifying, utilizing the one or more indexes, a set of high-performing user segments relating to the similar campaigns;
identifying, utilizing the one or more indexes, from the high-performing user segments, one or more user segments for recommendation as an audience for the particular campaign, wherein the one or more user segments are forecasted to be best-performing of the high-performing user segments, for the particular campaign,
wherein identifying the one or more user segments does not require historical performance information about the particular campaign; and
recommending the one or more user segments as an audience for the particular campaign.

15. The method of claim 14, wherein identifying the one or more user segments does not utilize historical performance information about the particular campaign

16. The method of claim 14, comprising recommending the one or more user segments as an audience for the particular campaign, wherein the particular campaign is an online advertising campaign.

17. The method of claim 14, wherein use of offline indexing allows faster determination of the recommendation than without the use of offline indexing.

18. The method of claim 14, wherein identifying high-performing user segments comprises correcting for bias caused by non-audience-related campaign factors affecting campaign performance, including testing that compares performance in campaign-unexposed users to performance in campaign-exposed users.

19. The method of claim 14, wherein the audience recommendation engine utilizes historical performance information and audience information associated with the similar campaigns, but does not require historical performance information associated with the particular campaign.

20. A non-transitory computer readable storage medium or media tangibly storing computer program logic capable of being executed by a computer processor, the program logic comprising:
audience recommendation engine logic, comprising:
similar campaign identification module logic for obtaining, storing and constructing one or more indexes using, information about each of a set of campaigns, including historical performance information and audience information, and for identifying, from the set of campaigns, utilizing the one or more indexes and information about a particular campaign, a set of similar campaigns to the particular campaign;
high-performing user segment identification module logic for identifying, utilizing the one or more indexes, a set of high-performing user segments relating to the similar campaigns; and
identification and recommendation module logic for identifying, utilizing the one or more indexes, from the high-performing user segments, one or more user segments for recommendation as an audience for the particular campaign, wherein the one or more user segments are predicted to be best-performing of the high-performing user segments, for the particular campaign, and for recommending the one or more user segments as an audience for the particular campaign.
